(19) United States
(12) Patent Application Publication
(10) Pub. No.: US 2011/0049405 A1
(43) Pub. Date: Mar. 3, 2011

(54) ACTUATING DEVICE

(76) Inventors: Martin Bill, Nohfelden (DE); Florian Lauer, Saarbrucken (DE); Michael Müller, Bexbach (DE)

(21) Appl. No.: 12/736,618

(22) PCT Filed: Jun. 5, 2009
(86) PCT No.: PCT/EP2009/004037

§ 371 Date: Nov. 12, 2010

(30) Foreign Application Priority Data
Jun. 26, 2008 (DE) 10 2008 030 453.0

(51) Int. Cl. F16K 31/02

(52) U.S. Cl. 251/129.15

(57) ABSTRACT

The invention relates to an actuating device, particularly for actuating valves that can be connected externally, comprising a housing (10) and a coil body (12) arranged therein and having a coil winding (14), which encloses a pole tube (16) at least partially, having a pole core (20) connected at the free end thereof, further comprising an armature (22) that is guided in a longitudinally displaceable manner at least in the pole tube (16) within an armature chamber (24) and interacts with an actuating pan (26) for actuating the respective valve part, wherein the pole tube (16) is designed in the form of a receiving sleeve for the armature (22), said sleeve being fixed to a fixed bearing point (124), wherein on a floating bearing point (116) for the receiving sleeve restoring means (112) engage thereon, effecting a force on the receiving sleeve that is directed away from the fixed bearing point (124).

The invention relates to an actuating device, in particular for actuating valves that can be connected externally, comprising a housing and a coil body arranged therein and having a coil winding, where said coil body encloses at least in part a pole tube to whose one free end a pole core is connected, with an armature which is guided to be longitudinally displaceable at least in the pole tube within an armature space, and which interacts with an actuating part for actuating the respective valve part, the pole tube being designed as a receiving sleeve for the armature, said receiving sleeve being fixed with its free end region at a fixed bearing point.

DE 10 2004 051 332 A1 discloses a generic actuating device. In the known solution, the pole tube on its one free end which projects out of the housing of the actuating device is provided with a flanged edge against which the armature can be supported in its one end-side travel position, the flanged edge leaving a center opening exposed into which a pressure equalization channel of the armature discharges which on its opposite side can be supported on the pole core in whose direction the pressure equalization channel discharges on its other side. On the opposite end, the pole tube has a flanged edge of less curvature which is directed in the opposite direction, and with which it is fixed in position between the coil body and the pole core both axially and also radially. As a result of the deflections toward the free edges of the pole tube, the latter is able to produce a certain longitudinal tolerance equalization in order to form a fitted mounting for parts of the actuating device. As a result of the defined clamping site of the pole tube between the pole core and the coil body, these tolerance equalization possibilities are limited.

To remedy this defect, DE 10 2005 061 184 A1 for a likewise generic actuating device has proposed forming the aforementioned flanged edge of the pole tube as a closed bottom part of a receiving sleeve which, supported by the pole core, is in contact with the latter, the bottom part of the pole tube being able to fit into the pole core such that it maintains its position, even if the armature for actuating a valve which can be connected to the actuating device moves back and forth and, in doing so, presses especially on the bottom part or is lifted off it by pulling itself. Since the flanged edge no longer borders an annular passage site, as shown above, but rather is closed, in this case, use for high pressures is also possible since in addition to pressure-tightness, a stiff, loadable pole tube system is formed.

The defined contact of the bottom part of the pole tube with the pole core achieves a type of fixing which enables tolerance equalization elsewhere on the pole tube in a widely drawn region. In this connection, it is provided that the pole tube on its free end discharges into a bead-shaped flange which is supported on the housing of the actuating device. The bead part of the flange is designed as a round bead; this makes it possible to position the free end region of the bead-shaped flange between the housing of the actuating device and housing parts of the adjoining valve body by clamping, and, as a result of the elastically resilient bead body, a type of articulation is implemented along which especially in the axial direction the pole tube with its installation length can be fitted within the coil body and the pole core.

On the basis of the prior art, the object of the invention is to further improve the known solutions while maintaining their advantages, specifically reliable, long-lasting actuating operation such that improved tolerance matching for a small installation size is achieved with little mechanical effort and therefore cost-efficiency. This object is achieved by an actuating device having the features of claim 1 in its entirety.

In that, as specified in the characterizing part of claim 1, at the loose bearing point for the receiving sleeve which forms the pole tube a reset means acts on the latter and applies a force to the receiving sleeve which is directed away from the fixed bearing point, tolerance equalization can be enabled within a very widely drawn framework, and this amount of equalization can be stipulated by way of a suitable selection of the reset means. Regardless of the possible production tolerances of the individual components of the actuation device, the associated tolerance can thus be compensated, and, in this respect, individually equalized via the reset means acting on the receiving sleeve.

The actuating device can be set up as a modular kit, and, with the respective reset means as part of the kit, tolerance equalization can also be undertaken with installation lengths which are changed accordingly. If the reset means is made preferably from an energy storage device, especially preferably in the form of a disk spring, the indicated tolerance equalization can be undertaken even if the service and operating temperatures for the actuating device should vary within a wide range.

In one especially preferred embodiment of the actuating device according to the invention, the receiving sleeve located outside the housing has a bottom part which is widened relative to the outside diameter of the receiving sleeve and at the site of the change in diameter has a deflected edge on which the reset means acts. Preferably, the respective reset means with its one action side acts on the housing and with its other action side acts in the deflection region between the cylindrical outer periphery and projecting edge of the receiving sleeve. In this way reliable support of the reset means on the assignable housing parts is achieved, as is favorable delivery of force in the indicated deflection region. As a result of the closed bottom part configuration, the actuating device can also be used for high pressure applications.

In another preferred embodiment of the actuating device according to the invention, it is provided that the deflected edge of the receiving sleeve delimits a peripheral gap which is connected to the armature space to carry media, which space accommodates the armature, delimited by the tubular part of the receiving sleeve. The bottom part of the receiving sleeve as the pole tube can especially advantageously deflect and rebound due to the peripheral gap and in this way can counteract the impact motion of the armature on the bottom part by damping it.

If preferably the bottom part in its middle is provided with an offset which projects cup-like in the direction of the armature space, the bottom part is accordingly stiffened in terms of its strength and improved in its indicated damping behavior. Due to the cup-like projection which can engage the armature space, the actuating device is closed to the outside by the bottom part of the receiving sleeve in the axial direction, saving installation space.

In another preferred embodiment of the actuating device according to the invention, it is provided that the deflected edge has two leg sections which run parallel to one another with the formation of a peripheral gap with a uniform width; this enhances the application of force if the armature strikes the bottom part and relieves the deflected edge as a bending site. Since corrosive media may be located in the peripheral gap, the receiving sleeve is preferably made from a corrosion-resistant, high-grade steel material. It can consist of magnetizable or nonmagnetizable high-grade steel depending on the configuration of the actuating device.

In another especially preferred embodiment of the actuating device according to the invention, there is a fixed bearing point for the receiving sleeve on its free end edge, and the fixed bearing point, as illustrated, is caulked to the pole core for this purpose. The loose bearing point is located on the opposite end of the pole tube in the region of the closed bottom part, in particular at the site at which the pole tube emerges from the housing of the actuating device, and support is achieved by the coil body and/or the housing parts which are penetrated by the pole tube. Due to the action of the reset means on the loose bearing point, the receiving sleeve with its inner periphery is accordingly stretched and equalizes possible unevenness in the region of the travel path of the armature. The receiving sleeve is also kept permanently stressed in tension; this is beneficial for the case in which the armature strikes the bottom part of the receiving sleeve. The vibration pattern which may have been applied due to the pretensioned receiving sleeve can be avoided.

The embodiment according to the invention is detailed below using exemplary embodiments as shown in the drawings. The figures are schematic and not to scale.

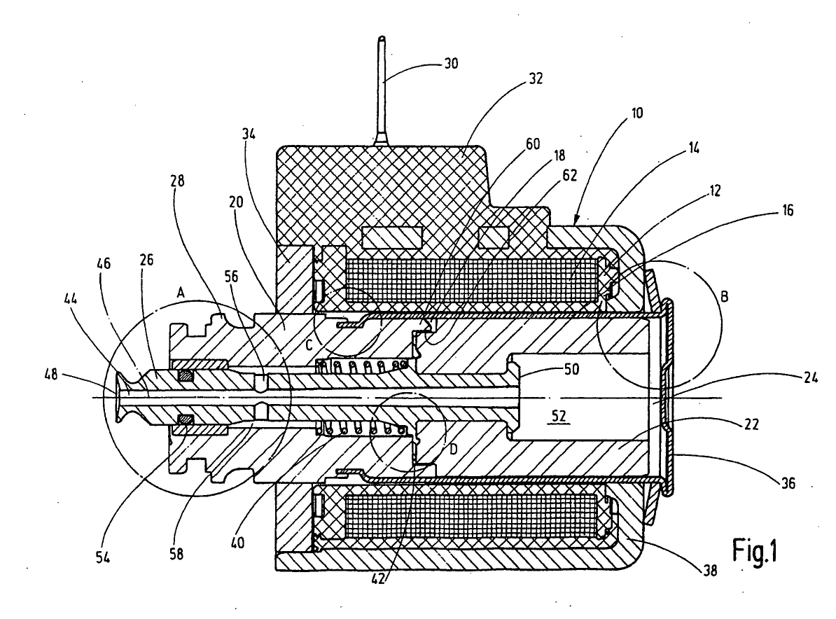

FIG. 1 shows, as a longitudinal section, the actuating device as a whole, but without a connected valve device;

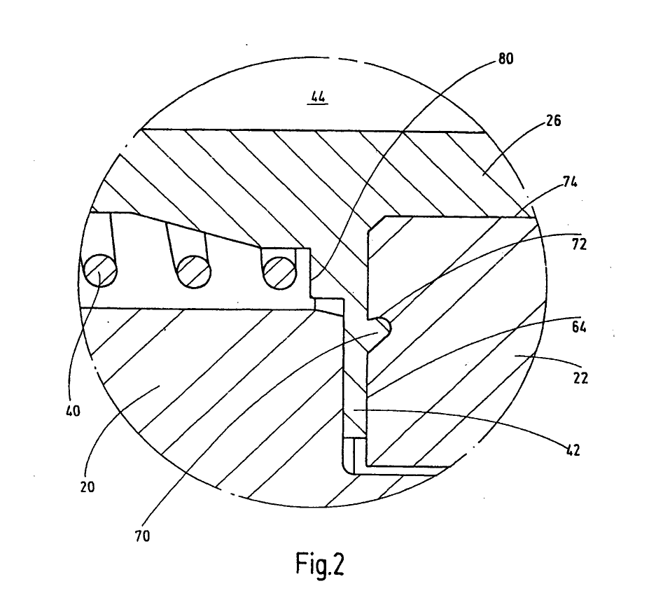

FIG. 2 shows an enlarged extract as shown in the circle D in FIG. 1;

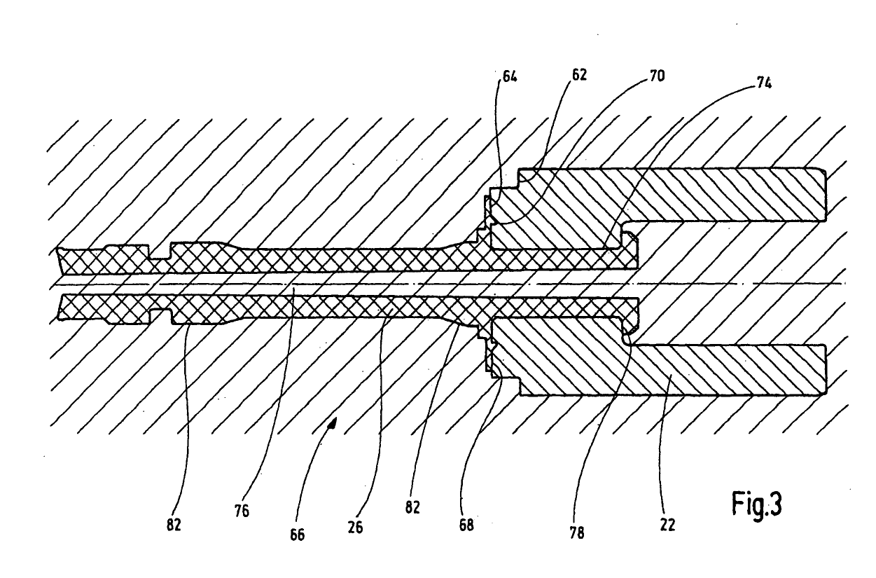

FIG. 3 shows, as a longitudinal section, part of the production form relating to the injection process of an actuating part onto the armature of the actuating device;

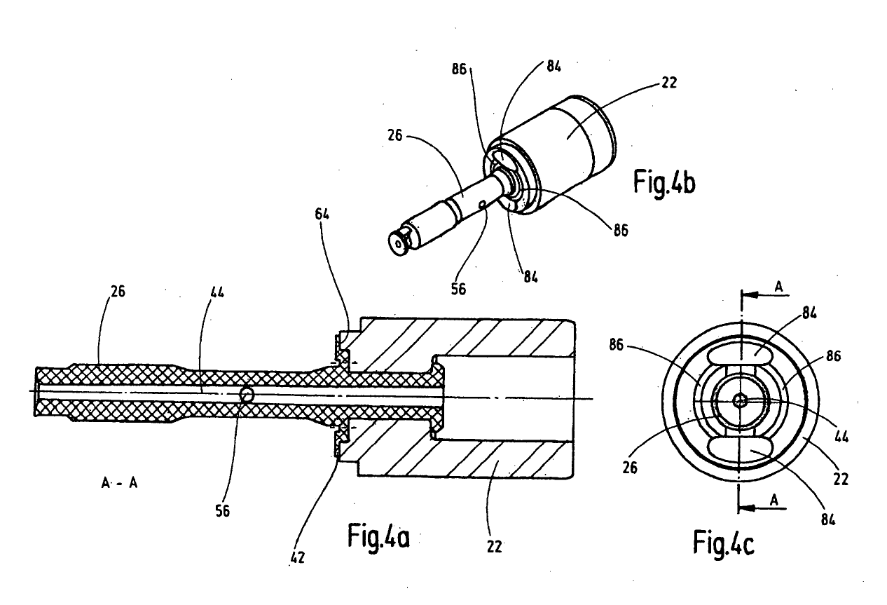

FIGS. 4a, 4b, and 4c show, in a longitudinal section in a perspective top view and in a front view, a second embodiment of an injection solution which has been modified relative to FIGS. 1 to 3;

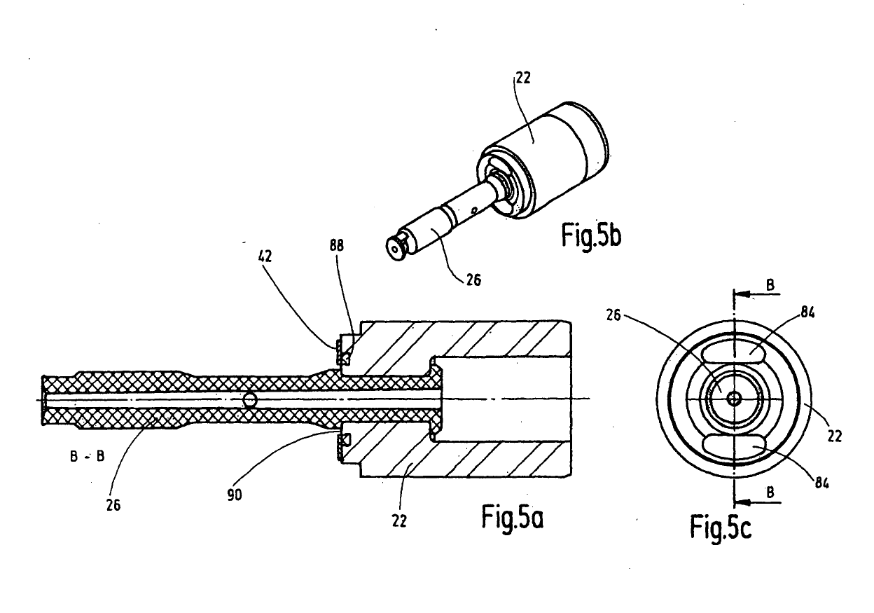

FIGS. 5a, 5b, and 5c show, in correspondence to FIGS. 4a, 4b, and 4c, a third embodiment of an injection solution;

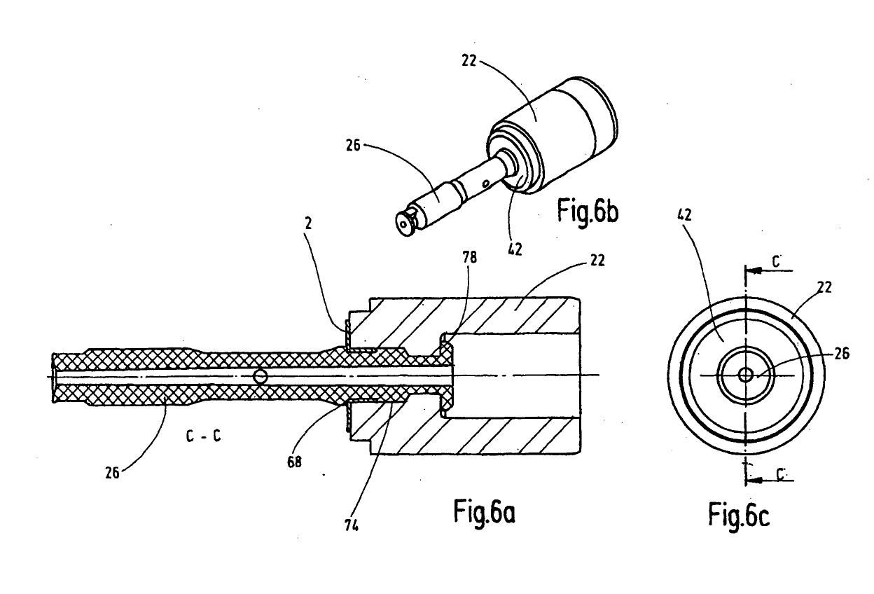

FIGS. 6a, 6b, and 6c show, in correspondence to FIGS. 4a, 4b, and 4c a fourth embodiment of the injection solution;

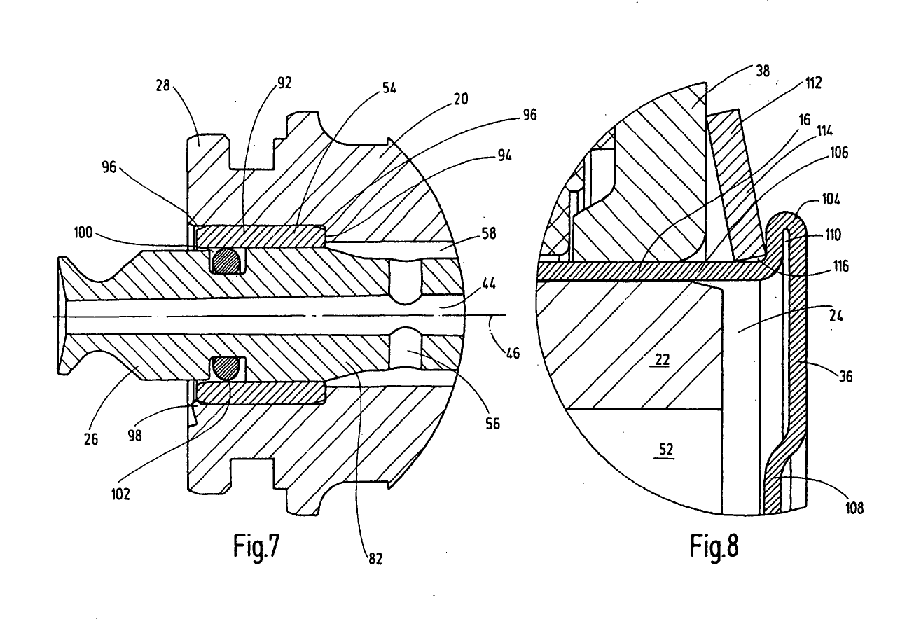

FIG. 7 shows an enlarged extract as shown in circle A in FIG. 1;

FIG. 8 shows an enlarged extract as shown in circle B in FIG. 1;

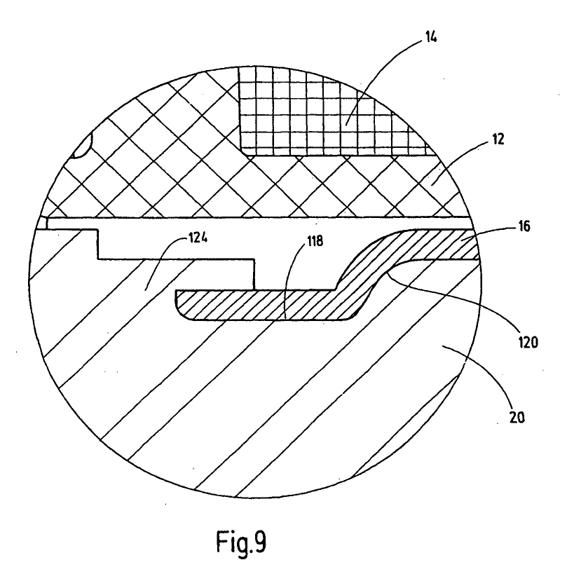

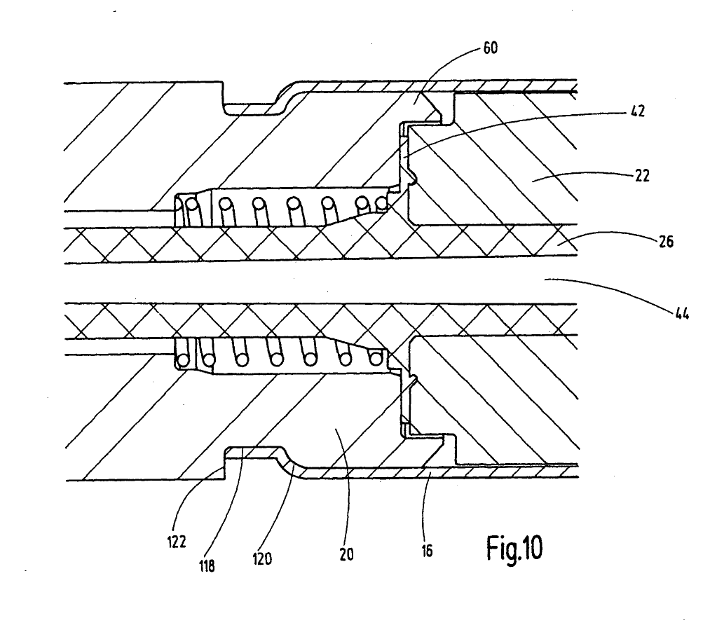

FIG. 9 shows an enlarged extract as shown in circle C in FIG. 1;

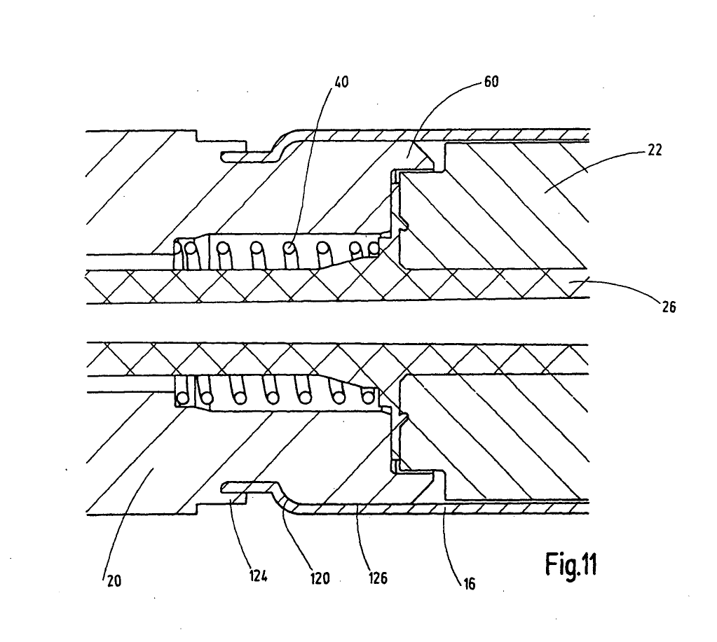

FIGS. 10 and 11 show, as a longitudinal section, the individual production steps for the detail solution as shown in circle C in FIG. 9.

The actuating device which is shown in a longitudinal section in FIG. 1 and which is also referred to as an “actuating or switching magnet” in the technical jargon has a housing designated as a whole as 10 with a coil body 12 located therein with a coil winding 14. This coil body 12 comprises at least in part a pole tube 16 which is essentially magnetically decoupled from a pole core 20 by means of a point of separation 18 in the form of a site which is left open. But the prior art also discloses solutions (not shown) in which a corresponding point of separation is formed by a weld or the like. Along the pole tube 16 an armature 22 is guided to be longitudinally displaceable in an armature space 24 which on its one free, front end interacts with a rod-like actuating part 26 for actuating fluid valves (not shown) of conventional design, especially in the form of pneumatic valves which are not detailed. To connect this valve, the pole core 20 on its free end is provided with a connecting flange 28. The connecting flange 28 on its outer periphery has depressed ring grooves for at least partially accommodating the corresponding elastomer gaskets and for routing the media flows.

To energize the coil winding 14 of the coil body 12, which preferably consists of at least one conductive copper wire, there is a plug part 30 which is preferably permanently connected to the remaining parts of the housing 10 by way of a sealing compound 32. Viewed in the direction of looking at FIG. 1, on the left side and to the outside, an annular pole plate 34 ending with the sealing compound 32 is inserted and is caulked accordingly for securely holding it in the housing 10 to the latter (not shown). In addition, the pole plate 34 encompasses the outer periphery of the pole core 20, which is held in the installation position shown in FIG. 1 in the actuating device by way of the valve device which is not detailed. The pole tube 16 is designed cup-like as a receiving sleeve, and the bottom part 36 of the pole tube 16 forms a stop limit for the armature 22 in its travel position, which is on the extreme right viewed in the direction of looking at FIG. 1. The sealing compound 32 together with the coil body 12 consists of a plastic material such as, for example, polyamide, preferably PA6. The sealing compound 32 on the top side of the actuating device along its bottom side engages recesses of a cup-like housing jacket 38, which is likewise a component of the housing 10. Both the housing jacket 38 and the armature 22, as well as the pole core 20 and the pole plate 34, consist of a metallic material, and all these parts can consist of the same material. The pole tube 16 is preferably produced from a high-grade steel material which can be magnetically conductive or nonconductive depending on the application.

If the coil winding 14 and therefore the coil are energized by means of the plug part 30, the armature 22 then is moved into its actuated position shown in FIG. 1, that is, viewed in the direction of looking at FIG. 1 from a right position into the left position which corresponds to the actuating position as shown in FIG. 1. In this traveling motion, the armature 22 entrains the rod-shaped actuating part 26 whose free end, for an actuating process on the pneumatic valve, which is not detailed, in each of its travel positions projects out of the housing 10 and particularly out of the pole core 20. In this traveling motion of the armature 22, viewed in the direction of looking at FIG. 1 to the left, an energy storage device in the form of a compression spring 40 is pretensioned, and as soon as the coil winding 14 is kept de-energized, the pretensioned compression spring 40 pushes the armature 22 back into its right initial position in which it can also make contact with the inside of the bottom part 36 of the pole tube 16. In this de-energized state, the connected valve device is switched open, de-energized. In one modified embodiment (not shown) of the actuating device according to the invention, it could also be provided that the energy storage device in the form of the compression spring 40 be moved into the connected valve device in order to induce the indicated reset motion of the armature 22 together with the actuating part 26.

But even when the current drops out, as a result of residual magnetism processes in the pole core 20 and in the pole plate 34, it can happen that the armature 22 with its one free face remains adhering to the adjacent face of the pole core 20 facing it. To avoid this, between the two faces within the armature space 22 an anti-adhesion means 42 is inserted which encompasses the rod-like actuating part 26 with a radial distance in order to effectively execute decoupling. The rod-shaped actuating part 26 is penetrated by a center channel 44 which extends along the longitudinal axis 46 of the armature 22 and the actuating part 26, which in this case also forms the optional axis of motion. The indicated middle channel 44 thus emerges into the exterior on the two opposite faces 48, 50 of the actuating part 26. In particular, the center channel 44 on the right face 50 of the actuating part 26 leads into an open space 52 of the armature 22, the open space 52 in turn leading into the armature space 24, carrying pressure and medium. In the region between a sealing site 54, which also forms a guide for the front end of the actuating rod 26 and the armature 22, there is a cross channel 56 which with its one end discharges into the center channel 44 and with its other end emerges into a center space 58 which is encompassed by the pole core 20.

The components including the center channel 44, cross channel 56, center space 58, open space 52, and armature space 24 form a type of pressure equalization system which is connected to a valve unit which is not detailed and compensates the pressure media originating from the valve unit such that the travel motion of the armature 22 together with the actuating part 26 is not adversely affected by possible pressure differences. Optionally, the pressure media guided in this way can also effectively support the actuating force to be applied by the armature 22 as a result of different area ratios. In the region of the point of separation 18, the pole core 20 with a lug-like annular projection 60 overlaps the stepping 62 of the armature 22 offset in this region such that in each travel position of the armature 22 it is guided within the annular projection 60 so that the size of the point of separation 18 changes depending on the direction of travel of the armature 22.

The rod-like actuating part 26 is formed from an injectable material which is injected onto, the armature 22, especially as shown in FIG. 3 in a connecting region 64. When reference is made here to injection, this includes conventional injection, casting, and diecasting methods. The injectable material of the actuating part 26 can fundamentally be any material which can be processed in this way. But preferably, a plastic material is used, especially a thermoplastically processable plastic. The use of polybutylene terephthalate (PBT) has proven especially advantageous; it allows injection molding at mass temperatures from 230° C. to 270° C. The plastic material used has the necessary strength and stiffness, and the sliding and wear behavior has proven very good in practical tests for the application under consideration here. In this exemplary embodiment, the entire actuating part 26 is formed from an injectable plastic material; but here it is also possible to form the actuating part 26 in the front region from a conventional metal rod material, which is then injected only in the transition region to the armature 22 by means of injectable material.

FIG. 3 shows an injection mold which is designated as a whole as 66, in part and in its fundamental structure. For the mold removal process this injection mold 66 is made in several parts (not shown) and can be assembled with its parts into the complete mold as shown in FIG. 3. The metal armature 22 is inserted into the injection mold 66 and on its free face forms the connection region 64. The possible injection surface 68 formed in this way is delimited to the outside by the wall of the injection mold 66 and is chosen such that it at least does not project above the free face of the armature 22 in this region. Furthermore, within the injection surface 68 a peripheral, annular groove-like depression 70 is made in the free face of the armature 22; it is shown enlarged in FIG. 2 and forms a type of undercut configuration 72 so that the injected plastic material can be held accordingly in the undercut in the armature 22 along the connecting region 64 by hooking underneath. Furthermore, the armature 22 has a centrally running center opening 74 which is penetrated by the actuating part 26, as shown in FIG. 3, a correspondingly inserted mold core 76 enabling this configuration. Since the center opening 74 emerges into the widening open space 52, another support surface is formed there as the second injection surface 78 of the armature 22. In the region of the second injection surface 78, the plastic material of the fastening part 26 overlaps the widening step formed here so that in the two directions of travel of the armature 22 secure anchoring of the actuating part 26 by way of the injection process is ensured.

The injection mold 66 as shown in FIG. 3 is designed so that the rod-like actuating part 26 widens radially to the outside with the formation of the already described disk-like anti-adhesion means 42. In this case, the pole core 20 is reliably decoupled from the armature 22, and the anti-adhesion means 42 also forms a type of stop protection for the armature 22. As FIG. 2 in particular shows, between the disk-shaped anti-adhesion means 42 and the remaining enclosure front of the actuating part 26, a stop step 80 is formed on which one free end of the energy storage device in the form of the compression spring 40 is supported. In this respect, the actual anti-adhesion means 42 is relieved of the force applied by the compression spring 40, which otherwise in any travel position of the armature 22 presses the rod-like actuating part 26 in the direction of the connecting region 64 of the armature 22. As furthermore follows from FIGS. 1 and 3, the center space 58 tapers to both sides by the rod-shaped actuating part 26 widening conically in diameter along two transition regions 82.

The embodiment as shown in FIG. 4 is at least modified such that in the connecting region 64 the injected plastic material has kidney-shaped widenings 84 to increase the linking mass, in turn the anti-adhesion means 42 being a one-piece component of the actuating part 26. As a result of the diametrically opposite annular depression sites 86 which adjoin the kidneys 84 on both sides as circle segments, the energy storage device in the form of the compression spring 40 need not rest entirely on the injected plastic material, but for improved support can be directly supported on the metal regions of the armature 22.

The embodiment as shown in FIG. 5 corresponds in terms of its fundamental structure to the embodiment as shown in FIG. 4; here, however, the anti-adhesion means 42 is securely connected on the face side as an anti-sticking washer via a corresponding engagement site 88 to the armature 22. In this case, the compression spring 40 with its one end directly adjoins the face of the armature 22 in the region of the annular gap 90, formed by the intermediate distance from the outer periphery of the fastening part 26 to the inner periphery of the anti-sticking washer of the anti-adhesion means 42, which has been formed independently.

In the embodiment as shown in FIG. 6, in turn the anti-adhesion means 42 consists of an anti-sticking cup which with its radial enclosure edge adjoins the face of the armature 22 and otherwise engages the middle opening 74 of the armature 22 with its bottom part which is cylindrically arched inward. In this respect, the actuating part 26 with its injectable plastic material only in the region of the second injection surface 78 directly adjoins the armature 22, and the first injection surface 68 is formed by the contact with the top side of the indicated anti-adhesion means 42.

FIG. 7 shows the actuating device with the sealing site 54, which seals the center space 58 to the outside relative to the free surrounding space into which the free end of the actuating part 26 projects. The indicated sealing site 54 is formed from a ring body 92 which is inserted into a shoulder-like widening 94 on the free end of the pole core 20, specifically, is pressed in there. For this pressing process, the ring body 92 toward its two free ends has conical insertion aids 96. The ring body 92 is formed from a material with good sealing and sliding properties; in addition to injectable plastics such as polyamide, nonferrous metal materials could also be used. To the extent good sliding properties are required, a PTFE material can also form the ring body 92. So that the ring body 92 remains securely in the receiver in the pole core 20, the pole core 20 can moreover be at least partially flanged along its free inner region so that the flange edge sections 98 to the outside form an effective stop boundary. The flange edge can also be made circumferential instead of the sectional configuration.

As FIG. 7 further illustrates, an elastomer gasket 102 is inserted into an annular groove 100 and ensures sealing between the center space 58 and the free exterior. Moreover, between the annular groove 100 and the adjacent transition region 82 of the actuating part 26, the diameter of the actuating part is widened and hence is in direct sliding contact with the inside of the ring body 92 which is preferably made as a compression sleeve; this yields additional sealing next to the elastomer gasket 102 and also ensures exact, end-side guidance for the actuating part 26 along the longitudinal or travel axis 46. On the side to the transition region 82 facing away, conversely, the outside diameter of the actuating part 26 is reduced in order to ensure unobstructed operation and to avoid any adverse effect on the entry process of the actuating part 26 at the site of the transition to the ring body 92.

As shown especially by FIG. 8 in conjunction with FIG. 1, the pole tube 16, which viewed in the direction of looking at the figures emerges on the right edge from the jacket 38 of the housing 10, is provided with a widened and deflected edge 104 which extends with a definable axial distance to the outside wall of the housing jacket 38. This configuration forms a type of loose bearing point. The edge 104 formed in this way forms the transition site between the cylindrical pole tube wall 106 and the bottom part 36 which runs transversely to it. Toward its middle, the bottom part 36 in the direction of the armature space 24 is provided with an offset 108 which projects in the right stop position of the armature 22 into its open space 52. Otherwise, the elastically resilient bottom part 36 forms a stop cushioning for the striking armature 22 if it assumes its travel position on the extreme right as shown in FIG. 1.

The flanged edge 104 enhances this effect by forming an elastically resilient articulation. A peripheral gap 110, into which medium can travel, leads into the edge 104 formed in this way; this in turn promotes stiffening of the entire system in this region. But it is especially advantageous that for the pole tube 16 in any temperature state, tolerance equalization is created by an elastically resilient reset means 112 in the form of an energy storage device, for example, formed from components of a disk spring 114, of which FIG. 8 shows one segment part. Instead of the individual segment disk springs 114 as shown in FIG. 8, essentially, however, there could be a disk spring assembly or other reset means, for example, in the form of a conventional helical spring which acts as a compression spring. A spring bellows or a pretensioned elastomer ring could also be used here if its use were possible at all based on the prevailing temperatures.

The reset means 112, preferably in the form of a disk spring 114, with its one end acts effectively on the free face of the housing jacket 38 and is supported with the other free end on a deflection region 116 at which the cylindrical pole tube wall 106 passes into the projecting edge 104. With respect to a high degree of corrosion resistance, the pole tube 16 is formed from a high-grade steel material, and the reset means 112 used also has the advantage that when vibrations occur on the actuating device, the pole tube 16 is decoupled relative to the housing 10. The projection selected to the right for the edge 104 relative to the free face of the housing jacket 38 is chosen such that the respective reset means 112 with its pretensioning can reliably act on the pole tube 16 and that the latter can be located on the remaining housing 10, saving installation space. The indicated offset 108, moreover, ensures that the pole tube 16 is reinforced in its pertinent bottom part region 36 so that residual deformations cannot occur in the event of striking of the armature 22.

The solution, as shown in FIGS. 9 to 11, shows the left linking site of the pole tube 16 to the stationary pole core 20 as a fixed bearing point. For this purpose, the pole core 20 in the direction of its annular projection 60 has an annular groove-like constriction site 118 which passes into the remaining outside diameter of the pole tube 20 in the direction of the annular projection 60 in an arc-shaped transition region 120 (cf. FIG. 1). FIG. 10 shows that the step-shaped transition region 122 facing away from the arc-shaped transition region 120 is initially undeformed and here forms only an abutting region for the free end of the free end edge of the pole tube 16 which is flanged or caulked. When this production step is completed, as shown in FIG. 11, in a second production step the step-shaped transition region 122 is caulked to the inside along a caulk surface 124 which is offset in the direction of the pole plate 34 relative to the remaining outside diameter of the pole core 20. In this way, the free end of the pole tube 16 is fixed not only axially and radially from both sides by the pole core material which is caulked in this region, but is also kept gas-tight, i.e., the solution shown here manages without an additional elastomer gasket or other sealing system between the pole core 20 in the region of its annular projection 60 and the fixing site on the free end edge of the pole tube 16.

Since these actuating devices are also used to some extent in the high temperature range, and this fundamentally damages the elastomer material of seals, a cost-favorable sealing alternative is implemented here. Due to the arc-shaped transition region 120, moreover, the pole tube is reliably guided without major kinks in the direction of the annular projection 60 on the outer periphery of the pole tube 22 so that unnecessary material stress for the thin-walled pole tube material does not occur. With respect to this guide distance 126 and the guide centering by way of the reset means 112 on the free end region of the pole tube 16, it is ensured that bulging processes which could possibly limit the free mobility of the armature 22 with its actuating part 26 do not occur.

The actuating device according to the invention is intended especially in the low pressure range for use in pneumatic valves even in the high temperature range; with a corresponding modification, however, other applications are also conceivable, especially for hydraulic valves. The very lightweight actuating device has very short switching and reaction times; and extremely high load cycles, which can be in the range of multiples of millions, can be achieved.

1. An actuating device, in particular for actuating valves that can be connected externally, comprising a housing (10) and a coil body (12) arranged therein and having a coil winding (14), where said coil body encloses at least in part a pole tube (16) to whose one free end a pole core (20) is connected, with an armature (22) which is guided to be longitudinally displaceable at least in the pole tube (16) within an armature space (24), and which interacts with an actuating part (26) for actuating the respective valve part, the pole tube (16) being designed as a receiving sleeve for the armature (22) which is fixed with its free end region at a fixed bearing point (124), characterized in that at a loose bearing point (116) for the receiving sleeve a reset means (112) acts on the latter and applies a force to the receiving sleeve which is directed away from the fixed bearing point (124).

2. The actuating device according to claim 1, characterized in that the reset means (112) is formed from an energy storage device, preferably in the form of a disk spring (114).

3. The actuating device according to claim 1 or 2, characterized in that the receiving sleeve located outside the housing (10) has a bottom part (36) which is widened relative to the outside diameter of the receiving sleeve and at the site of the change in diameter has a deflected edge (104) on which the reset means (112) acts.

4. The actuating device according to one of claims 1 to 3, characterized in that the reset means (112) with its one action side acts on the housing (10) and with its other action side acts in a deflection region (116) between the tubular outer periphery and the projecting edge (104) of the receiving sleeve.

5. The actuating device according to claim 3 or 4, characterized in that the deflected edge (104) of the receiving sleeve delimits a peripheral gap (110) which is connected to an armature space (24) to carry media, which space holds the armature (22) delimited by the tubular part of the receiving sleeve.

6. The actuating device according to claim 5, characterized in that the bottom part (36) in its middle is provided with an offset (108) which projects cup-like in the direction of the armature space (24).

7. The actuating device according to claim 6, characterized in that the armature (22) in the middle has a cylindrical open space (52) which accommodates the offset (108) at least in one stop position of the armature (22) on the bottom part (36) of the receiving sleeve.

8. The actuating device according to one of claims 5 to 7, characterized in that the deflected edge (104) has two leg sections which run parallel to one another with the formation of a peripheral gap (110) with a uniform width.

9. The actuating device according to one of claims 1 to 8, characterized in that there is a fixed bearing point (124) for the receiving sleeve on its free end edge and the loose bearing point (116) on its opposite end is located in the region of the closed bottom part (36) on which the receiving sleeve emerges from the housing (10) on the end side.

10. The actuating device according to one of claims 1 to 9, characterized in that the receiving sleeve is made of a high-grade steel material.
